(19) United States
(12) Patent Application Publication
(10) Pub. No.: US 2005/0010495 A1
(43) Pub. Date: Jan. 13, 2005

(54) Custom product order management system

(76) Inventors: Pochun Shih, Cerritos, CA (US); Yvone YiFang Tsai, San Marino, CA (US); YongKang Yu, El Monte, CA (US); Shu-Fang Sylvia Lee, Walnut, CA (US)

Correspondence Address: SHELDON & MAK, INC, 225 SOUTH LAKE AVENUE, 9TH FLOOR, PASADENA, CA, 91101, US

(21) Appl. No.: 10/614,689

(22) Filed: Jul. 7, 2003

(51) Int. Cl. G06F 17/60; G06G 1/14

(52) U.S. Cl. 705/27; 705/26; 705/22

(57) ABSTRACT

An order management system for complex combination of custom fabricated goods includes a transaction facility for processing orders and a remote facility associated with a fabrication site. A base computer at the transaction facility is programmed for interactive generation of orders while permitting only non-conflicting combinations of options, elements, and details of the goods, which can be windows and window accessories for buildings. Also disclosed is a method for interactively generating custom product orders.

### BACKGROUND

The present invention relates to product order processing, and more particularly to the facilitation of order taking and processing thereof for products having a multiplicity of optional configurations.

Computer-based product order processing, although a relatively recent development, is well known. However, products that are custom-made and/or which have multiplicities of configuration variables have generally not been the objects of this technology, for a number of reasons. For example:
1. Buyers are not sufficiently familiar with the product to know what configurations are workable;
2. Interrelations between certain parameters often give rise to unexpected and undesired results;
3. Assistance by live operators is impractical in that extensive training is often required and complex information communicated to buyers is not understood; and
4. Ordering is excessively time-consuming in that many correlated parameters have to be individually and repetitively specified.

These difficulties are particularly evident in the case of building window products. The windows of a building can have a great variety of configurations, yet typically with some common characteristics among at least some of the windows, particularly windows of the same room. Among the parameters and options to be dealt with are nominal width and height, type (single, side-by-side, bay), style, color, louver configuration, frame type, mounting type, shutter size, type, number of panels and fold configuration, T-post type and position, divider position, rail locations and design. These considerations are further complicated in the case of retrofit installations by the presence or absence of existing moldings and sills, which themselves may be differently configured.

Thus there is a need for an order management system that is effective, reliable, and easy to use, yet is reasonably secure from theft or inadvertent removal, and that otherwise overcomes the disadvantages of the prior art.

### SUMMARY

The present invention meets this need by providing an order management system that is particularly suitable for processing orders for custom goods having complex specifications while avoiding inconsistent specifications. In one aspect of the invention, the system includes a computer having program memory, working memory, and data memory; a graphical user interface operatively connected to the computer; and the computer being programmed for displaying an order form comprising a sequence of selection windows for receiving respective specifications of a custom product being ordered by a user of the system, the selection windows displaying specification options as defined by stored product data of the data memory, and at least some of the selection windows displaying restricted specification options dependent on previously selected specifications, for avoiding selection of inconsistent specifications by the user. The system can also include a network interface for permitting the graphical user interface to be remotely connected to the computer. The graphical user interface can be directly connected to the computer, the network interface permitting plural counterparts of the graphical user interface to be operatively connected to the computer for access by multiple users. The system of claim 2, wherein the network interface can be implemented for communication over a publically accessible network, which can be the Internet. The computer can be programmed for log-in of users for limiting access to the order form to authorized users. The computer can be further programmed for transmitting the specifications ordered by the user to a remote facility for filling the order.

The order form can also have an entry window for receiving a numerical specification element, an associated selection window preferably being selectively disabled depending on comparison of the numerical specification element with a predetermined value. The system of claim 8, wherein the associated selection window can have a set of selection options, a subset only of the selections being disabled in response to entry of the numerical specification element. The associated selection window can have a default setting, the default setting being dependent on user input at the entry window.

The selection windows can include a selection button, the computer being further programmed for changing the specification options in another of the selection windows in response to operation of the selection button. One of the selection windows can have a default setting, the default setting being dependent on user input at a different selection window.

In another aspect of the invention, a method for interactively entering custom product orders for complex custom goods, includes providing a computer having control of a graphic user interface; under control of the computer, displaying an order form comprising a sequence of selection windows; displaying specification options in association with respective ones of the selection windows as defined by stored product data of the data memory; sequentially receiving in the selection windows respective specifications of a custom product being ordered by a user of the system; and in association with at least some of the selection windows, restricting the display of specification options dependent on previously selected specifications, for avoiding selection of inconsistent specifications by the user. The method can also include displaying a selection window as a selection button, changing the specification options in another of the selection windows in response to operation of the selection button. The method can also include transmitting the specifications ordered by the user to a remote facility for filling the order.

### DRAWINGS

These and other features, aspects, and advantages of the present invention will become better understood with reference to the following description, appended claims, and accompanying drawings, where:

FIG. 1 is a pictorial block diagram of a custom product order management system according to the present invention;

FIG. 2 is a flow chart of a computer process for the system of FIG. 1;

FIG. 3 is a flow chart showing a portion of the computer process within region 3 of FIG. 2 in greater detail; and

FIGS. 4A and 4B (in two parts, collectively referred to as FIG. 4) is a pictorial diagram of a web page order form of the computer process of FIG. 2, FIG. 4A being an upper portion thereof, FIG. 4B being a lower portion.

### DESCRIPTION

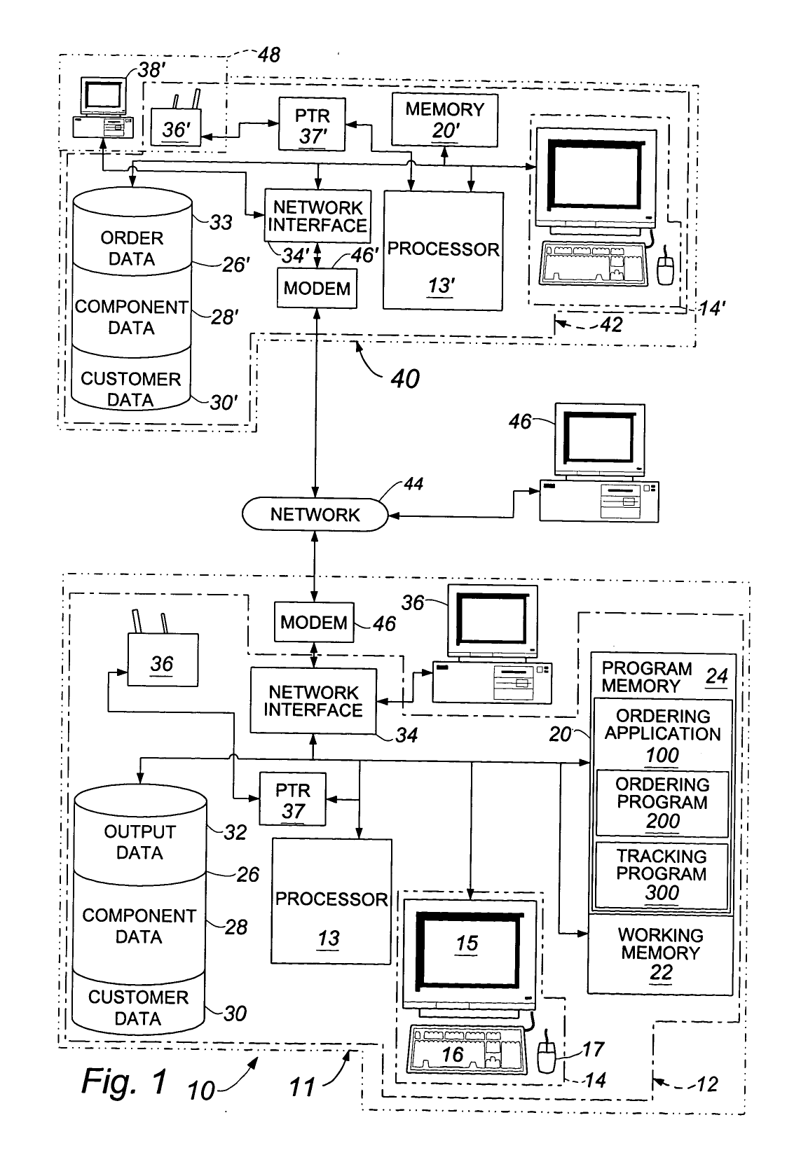

The present invention is directed to a computer based order management system that is particularly effective as applied to products having multiplicities of optional features and dimensions, not all combinations of options being compatible. With reference to FIGS. 1-4 of the drawings, an order management system 10 for use in association with a transaction facility 11 includes a base computer 12 having a base processor 13, an operator interface 14 including a screen display 15, a keyboard 16, and a pointing device or mouse 17. The base computer 12 also includes a base memory 20 having working memory 22 and program memory 24, and mass memory 26 for storing component data 28, customer data 30, and output data 32. The base computer 12 also includes a network interface 34 and typically includes a printer 36 that communicates with the processor 13 through a printer interface 37. The transaction facility 11 can also include a local network computer 38 (or more than one) that is connected to the network interface 34.The network interface 34 communicates with a suitable communication network 38

The system 10 also includes a remote facility 40 having a remote computer 42. The remote computer 42 has counterparts of the base processor, designated remote processor 13′; the operator interface, designated 14′; the base memory, designated remote memory 20′; the mass memory, designated 26′ (including counterparts of the component data, designated 28′, and the customer data, designated 30′) and order data 33′; the network interface, designated 34′; the printer, designated 36′; and the printer interface, designated 37′.

Communications between the transaction facility 11 and the remote facility 40 are over a network 44 which can be a publically accessible network such as the Internet, a user computer 45 (being typically one of a multiplicity of such computers) being shown connected to the network 44 in FIG. 1. For this purpose, a suitable modem 46 is connected between the network interface 34 of the base computer 12 and the network 44, and a counterpart modem, designated 46′ is connected between the network 44 and the network interface 34′ of the remote computer 42. It will be understood that numerous other configurations of communication paths can be established between the transaction facility 11 and the remote facility. As further shown in FIG. 1, the remote printer 36′ can be located in a fabrication facility 48 that is associated with the remote facility 40. The fabrication facility 48 can also have a counterpart of the local network computer located, designated remote network computer 38′ therein and connected to the network interface 34′ of the remote computer 42.

According to the present invention, the system 10 facilitates ordering complex collections of custom-fabricated products while permitting only non-conflicting combinations of specifications. The following description is directed to the system 10 being implemented for generating orders for custom building windows and accessories therefore, it being understood that the system can also be configured for generating orders for other complex custom-fabricated products.

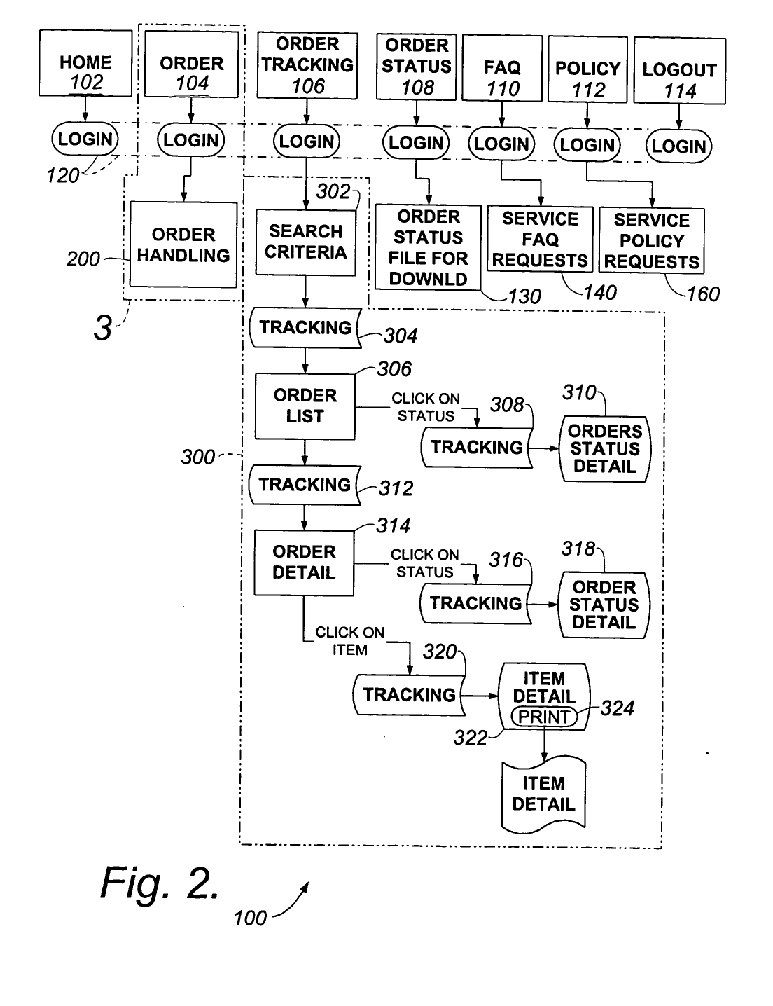

With particular reference to FIG. 2, a computer order management process 100 with which the base computer 12 is programmed provides, following power-up and initialization, an addressable plurality of web pages for access from the network 44, including a home page 102, an order page 104, an order tracking page 106, an order status page 108, a “frequently asked questions” (FAQ) page 110, a policy page 112, and a logout page 114 using web server implementations that are known in the art. Access to operational features of some or all of the web pages 104-114 is conditioned by successful identification of authorized users at a logon window 120. For example, a user name and password (which may be obtained pursuant to an e-mail requiest) are normally required for access to at least the order page 104 and the order tracking page 106. Following successful login control passes from the order page 104 to an order handling process 200, described below. Similarly following login, control passed from the order tracking page 106 to an order tracking process 300, described in limited detail below, the details of the order tracking forming no part of the present invention. In like manner, control passes from the order status page 108 to an order status file step 130, from the FAQ page 110 to a service FAQ step 140, and from the policy page 112 to a service policy step 160, these portions of the management process 100 being conventionally implemented and not described further herein.

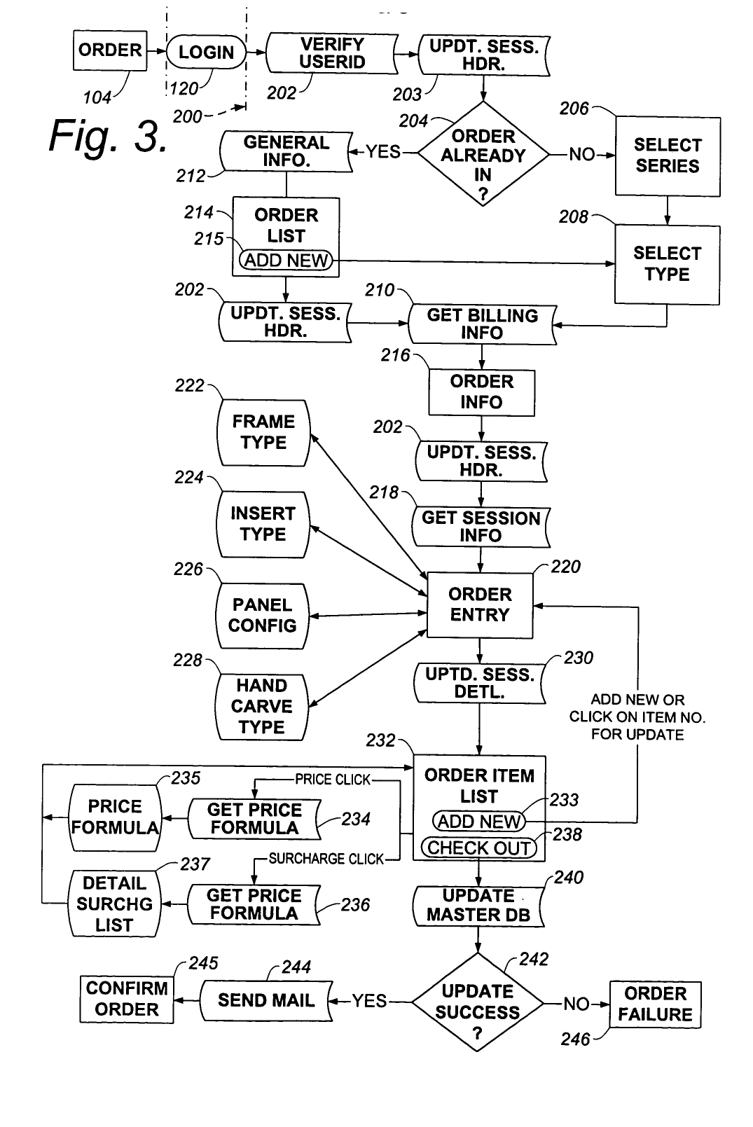

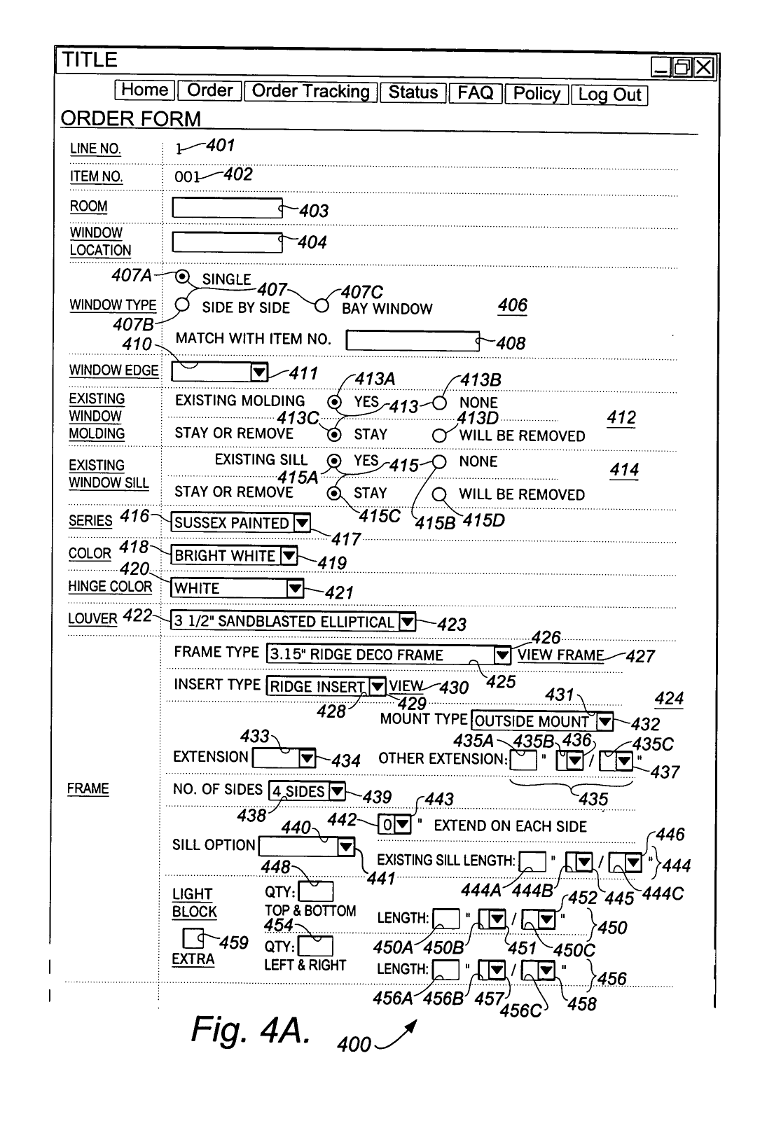

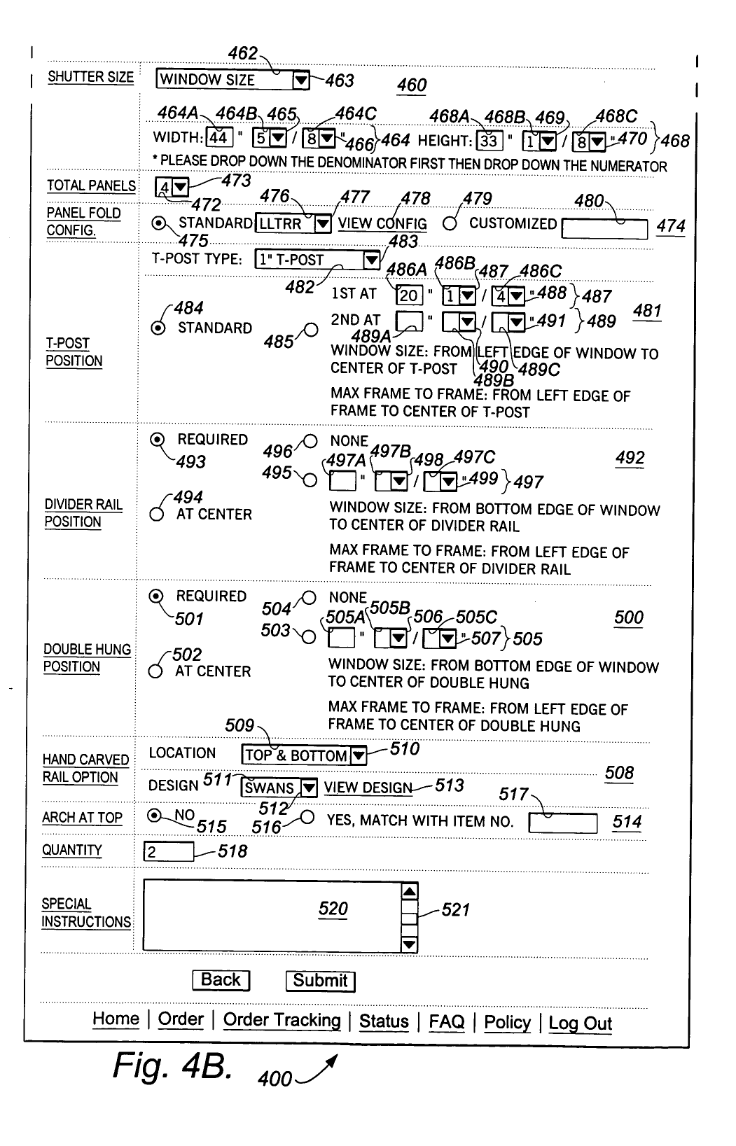

With particular reference to FIGS. 3 and 4, the order handling process 200 is entered at a verify user ID step 202 (which may be performed in the context of the login page 120, followed by an update session header step 203, then a test order in step 204 in which the existence of a pending order in the current session is determined. If not, control passes to a select series step 206 in which a basic product series (or “program”, such as of particular shape characteristics, material and finish of goods to be ordered) is selected by the user, followed by a select type step 208 wherein the goods are specified to be standard or non-standard, control then passing to a billing data step 210 in which billing information is obtained from the customer data 30. The selection of series can be facilitated by screen displays of representative product features of each program.

Following a positive result from the test order in step 204, control passes to a general information step 212 for obtaining session data, and then to a list order step 214 in which a list of the current orders is displayed. Also displayed is an “ADD NEW” button 215 for allowing a new order to be placed in the session. Activation of the ADD NEW button 215 passes control to the select series step 206, described above, control otherwise passing, following time-out or activation of a continue button (not shown), to a counterpart of the update session header step 202, and thence to the billing data step 210, described above.

Following the billing data step 210, the order handling process 200 updates the order data in an order information step 216, and executes another counterpart of the update session header step 202. Next, the current session data is retrieved in a get session step 218 in preparation for an order entry step 220. In the order entry step 220, the user is invited to specify various characteristics of the goods. For example in ordering building windows and accessories therefor, the user can specify frame type as indicated at 222, insert type as indicated at 224, panel configuration as indicated at 226, and hand carve type as indicated at 228. After the order entry step 220, the session data is further updated in a session detail step 230, followed by a counterpart of the list order step, designated item list step 232, in which a counterpart of the ADD NEW button, designated 233, returns control to the order entry step 220 for the user to specify additional items or, by clicking on an item, modifying the order data for that item. In the order list step 232 the items being ordered are listed, with their unit prices and surcharge prices. The user can click on “price” (PRICE CLICK) for retrieval of a price formula in a get formula step 234, followed by display of detail pricing for that item in a pricing step 235. The user can also click on “surcharge” (SURCHARGE CLICK) to execute a counterpart of the get formula step, designated 236, followed by a detailed listing of prices and surcharges in a detail pricing step 237. Following either of the pricing steps 235 or 237, control returns to the order list step 232. The order list step 232 also presents a “CHECK OUT” button 238 which when activated transfers control to an update database step 240 in which the order data is stored in a master database and inventory is reserved in preparation for fabrication of the items ordered.

Finally, the order handling process 200 concludes with a test update step 242 that checks for successful updating of the master database. If successful, a copy of the order is mailed to the user in a send mail step 244, with brief information of the order being sent to the customer through e-mail and the order is confirmed in a confirmation step 245; otherwise, control passes to a failure step 246. At the conclusion of the process 200, and at suitable intermediate stages, the user has the option of navigating in a conventional manner to other portions of the order management process 100, such as the home page 102, the FAQ page 112, etc., as well as to place another order or to exit the system.

As further shown in FIG. 2, the order tracking process 300 proceeds by obtaining data by which pending orders and shipping status can be identified, in a search criteria step 302. Such data can include customer identification, purchase order number, work order number, and invoice number. Control next passes to a tracking step 304 in which items meeting the search criteria are identified, and a list is displayed to the user in an order list step 306. The user has the option to “click on status” from the order list step 306, control passing to a counterpart of the tracking step, designated 308, and thence to an orders status detail step 310 in which the status of the orders matching the search criteria is displayed in some detail. The user can click on a particular order (or order number), control passing to another counterpart of the tracking step designated 312, followed by an order detail step 314 in which the selected order is displayed in greater detail. The user also has the option to “click on status” from the order detail step 312, control passing to a further counterpart of the tracking step, designated 316, and thence to a counterpart of the status detail step, designated 318 in which the status of the order is displayed in greater detail. Another option from the order detail step 314 is to click on a particular item, resulting in, following yet another counterpart of the tracking step, designated 320, detail status of that item being displayed in a detail item step 322, and a “PRINT” button 324 is also displayed for generating a printout of the item status.

With particular reference to FIG. 4, a web page order form 400 suitable for use with the present invention to order custom building window shutters is implemented in combination with programming of the base computer 12 for the order handling process to facilitate consistent and non-conflicting specifications. The order form 400 automatically generates a LINE NO. field 401 and an ITEM NO. field 402, presenting a ROOM entry field 403 and a WINDOW LOCATION field 404 as shown in FIG. 4A. The ROOM entry field 403 is used for automatic posting of appropriate specifications for all window shutters of the same room alike, although the user is permitted to override at least some of those. The LOCATION field 404 is used for identifying window location assignments on labels or other paperwork to be shipped with the shutters, to facilitate proper installation. Optionally, the LOCATION field can be used to coordinate specifications for shutters facing in the same direction or on common walls, whether in single or multiple rooms at the same site.

Following the LOCATION field 404 is a WINDOW TYPE zone 406 having type radio buttons 407 in including 407A for specifying a single window, 407B for specifying side-by-side windows, and 407C for specifying a bay window. Also included is a MATCH entry field 408 for indicating a previously specified item number with which to match the present item being ordered. Next is a WINDOW EDGE selection window 410 having a conventional expansion button 411 for activating an expanded display of available choices among window opening cross-sectional shapes, exemplary choices being Square, ¾ inch Bull and 1 ¼ inch Bull. It will be understood that as used herein, the term “selection window” is logically inclusive of “radio button” in that in either case there is selection among (or between) predefined choices.

The order form 400 includes an EXISTING MOLDING zone 412 having radio buttons 413 for indicating the status of existing window molding at the location being specified, including 413A for indicating presence of such molding, 413B for indicating no molding, 413C for indicating that existing molding will stay, and 413D for indicating that the existing molding will be removed. It will be understood that other forms of such indications are also possible, including only three radio buttons for indicating, respectively, no existing molding, existing molding to be retained, and existing molding to be removed. In the arrangement shown in FIG. 4A, activation of the button 413B (no molding) can be programmed to result in the buttons 413C and 413D (for indicating the disposition of existing molding) being automatically blanked; similarly, activation of the button 413A (existing molding) can automatically activate a default one of the buttons 413C and 413D. Similarly, an EXISTING SILL zone 414 having radio buttons 415 for indicating the status of an existing window sill at the location being specified, including 415A for indicating presence of such sill, 415B for indicating no sill, 415C for indicating that an existing sill will stay, and 415D for indicating that the existing sill will be removed.

Also, a “Program” or SERIES selection window 416 having an expansion button 417 allows the user to select a model, design category or program of the louver product being ordered. Similarly, a COLOR selection window 418 having an expansion button 419 allows the user to select a color of the louver product. A HINGE COLOR selection window 420 having an expansion button 421 allows the user to select a hinge color of the louver product, the window 420 being set to a default color matching the previous selection of louver product color from the window 418. A LOUVER selection window 422 having an expansion button 423 allows the user to select a louver type (such as elliptical or S-shaped cross-section), finish (such as smooth or sandblasted), color (a selected paint color, stain color or primed) and section width (such as 1 ⅞, 2 ⅜, 3 ½, and 4 ½ inch) of the louver product. The selection can be limited according to available combinations. For example, louvers having a sandblasted finish may be available only in painted colors, and S-shaped louvers can be offered in fewer than all of the otherwise available widths. The LOUVER selection window thus provides only combinations of selections that are consistent with available product configurations. It will be understood that although the louver selection in this exemplary configuration of the order form 400 is from a single list of allowed combinations, it is also contemplated that the selection can be made from plural windows. For example, the selection of type can be from one window, finish from another window, and separate windows for width and color can have available selections that are dependent on the selections of type and finish.

The order form 400 also includes a FRAME zone 424 including a FRAME TYPE selection window 425 having an expansion button 426, an INSERT TYPE selection window 428 having an expansion button 429, and a MOUNT TYPE selection window 431 having an expansion button 432. Exemplary frame types include a face or “Deco” type having a flush rear mounting surface and a louver panel cavity that extends rearwardly nearly to the mounting surface, a “Z” frame having an inside portion that projects rearwardly from a flange mounting surface and having the panel cavity typically extending rearwardly of the mounting surface, an “L” frame having the panel cavity spaced substantially forwardly of the mounting surface, and separate hang strips of rectangular cross-section. Preferably the FRAME TYPE selection window 425 has a frame view button 427 associated therewith for displaying a cross-sectional and/or other depiction of the selected frame configuration. The button 427 can be implemented for generation of a “pop-up” window to display the configuration, including its important dimensions, whenever the user's pointer cursor is moved over the button, the pop-up window being extinguished when the cursor is moved away. Some frame types can optionally be provided with channels for receiving decoratively shaped inserts. The INSERT TYPE selection window 428, when opened, shows the available inserts, if any, for the frame type selected. Preferably the INSERT TYPE selection window 428 has an insert view button 430 associated therewith for displaying a cross-sectional and/or other depiction of the selected insert, which can be implemented in the manner described above for the frame view button 427. The INSERT TYPE window 428 can be “grayed out” or otherwise indicated to be unavailable when a frame type not accommodating an insert is selected. The mount type selection is between inside (within the window frame) and outside (on the wall or on molding if present). The MOUNT TYPE selection window 431 can be made non-operative except when the selected frame type is hang strips, that type being typically the only one that can be used with inside mounting as well as outside.

The FRAME zone 424 also includes a frame EXTENSION selection window 433 having an expansion button 434 for selecting an offset distance from the window opening to the frame in outside mount configurations. The selections can include those most likely to be chosen, and the available selections are preferably limited to those that are consistent with the frame type and mounting previously selected. For example, standard default offsets can be zero (0) for the Deco and L type frames, ½ inch outward (positive) for hang strips, and 3/16 inch inward (negative) for Z type frames. Other selections can include ¾ inch and 1 ¼ inch outward to accommodate “bull nose” wall conditions, and ¾ inch and 1 ¾ inch inward for Deco frames when outside clearance is limited. Additionally, an extension window group 435 provides for additional specifications of the extension, limited as described above to ranges that are consistent with the selected frame type. In particular, an extension inch window 435A can receive integer inch offset data, an offset numerator window 435B having an expansion button 436 can receive the numerator of fractional inches, and a denominator window 435C having an expansion button 437 can receive the denominator of fractional inches. Preferably the base computer 12 is programmed so that when the denominator is selected first, a the numerator window 435B when opened displays a limited set of numerators that is consistent with the denominator selection. For example, when the denominator 4 is selected, the numerator window 435B displays just the numerals 1, 2 (optionally), and 3.

A (number of) SIDES selection window 438 having an expansion button 439 is also included in the frame zone 424 for selecting 2-sided, 3-sided, 3-sided-inverted, and 4-sided frames. When inside mount hang strips are selected, the window 438 can display 2-sided and 3-sided and the expansion button 439 can be disabled (grayed out). A SILL OPTION selection window 440 having an expansion button 441 permits selection of a sill under certain conditions. For example, the user can select a Deco sill when the Deco frame type is selected and 3-sided frame is selected. A sill extension selection window 442 having an expansion button 443 provides for specification of a selected distance that a new sill is to extend beyond the sides of the window opening.

An existing sill length window group 444 is enabled under certain conditions, for entry of the length of an existing sill. For example, the window group 444 can be enabled if “Marble Sill Cap” is selected and an existing sill is indicated to be retained (sill stays 415C is activated). When the window group 444 is enabled, a sill inch window 444A can receive integer inch length data, a sill numerator window 444B having an expansion button 445 can receive the numerator of fractional inches, and a denominator window 444C having an expansion button 446 can receive the denominator of fractional inches of the existing sill length, in a similar manner to the window group 435, described above.

Finally, the frame zone 424 includes means for specifying optional light block strips that are particularly useful in certain shutter frame configurations. A horizontal light block quantity entry window 448 provides for entry of a top and bottom light block quantity, of length specified using an associated horizontal block LENGTH window group 450. In a similar manner to the window groups 435 and 444, described above, a horizontal block inch window 450A can receive integer inch length data, a block numerator window 450B having an expansion button 451 can receive the numerator of fractional inches, and a block denominator window 450C having an expansion button 452 can receive the denominator of fractional inches of the horizontal light block length. In like manner, a vertical light block quantity entry window 454 provides for entry of a left and right light block quantity, of length specified using an associated vertical block LENGTH window group including a vertical block inch window 456A for receiving integer inch length data, a block numerator window 456B having an expansion button 457 for receiving the numerator of fractional inches, and a block denominator window 456C having an expansion button 458 for receiving the denominator of fractional inches of the vertical light block length. The light block quantity entry windows are preferably operable only when the previous selections and entries on the order form 400 are consistent with inclusion of corresponding light block strips. For example, light block strips would not be. consistent with 4-sided Deco, Z, or L frames, and vertical light block strips would be inconsistent with inside mount hang strips. Contrastingly, horizontal light block strips are particularly useful (and possibly presumed to be provided) with inside mount hang strips. Accordingly, it is preferred to include means for indicating whether specified light block strips would involve extra charges or not. Thus a preferred exemplary implementation of the frame zone 424 includes an extra light block indicator 459 that is activated whenever specified light block strips exceed a number to be provided at no extra cost with particular frame selections. In addition to the inside mounted hang strip situation described above, it is preferred that a single horizontal light block strip be provided at no extra charge when a 3-sided frame with sill is specified, the light block indicator being inhibited accordingly.

The order form 400 further includes a SHUTTER SIZE zone 460 as shown in FIG. 4B, including a SIZE selection window 462 having an expansion button 463, a horizontal block WIDTH window group 464, and a HEIGHT window group 468. In an exemplary and preferred configuration, the SIZE selection window 462 has a default selection of “WINDOW SIZE”, and other selections that can include Maximum Frame to Frame, as described above for the FRAME TYPE and MOUNT TYPE selection windows 425 and 431. In a similar manner to previously described window groups, the WIDTH window group 464 includes a width inch window 464A, a width numerator window 464B having an expansion button 465, and a width denominator window 464C having an expansion button 466; and the HEIGHT window group 468 includes a height inch window 468A, a height numerator window 468B having an expansion button 469, and a height denominator window 468C having an expansion button 470, for specifying shutter size dimensions.

The number of panels to be included in the shutter assembly being ordered is specified in a panel quantity selection window 472 having an expansion button 473. The available numbers of panels is preferably automatically generated, based on the previously specified shutter width, and displayed in the selection window 472 upon activation of the expansion button 473. Associated therewith is a FOLD zone 474 in which a specific folding hinge configuration is specified. A standard fold radio button, when activated, enables a fold selection window 476 having an expansion button 477. The selection window 476, when opened displays standard fold configurations that are consistent with the number of panels as selected using the quantity selection window 472 and the shutter size as defined using elements of the SHUTTER SIZE zone 460. A view fold button 478 is provided, for activating a pop-up window to show the panel fold configuration as described above for the frame view button 427. In the following examples, the symbol “L” denotes a panel having a hinge to the left; “R” denotes a panel having a hinge to the right, “T” denotes a T-post, and reading left to right denotes a corresponding left-to-right order of elements as viewed from inside the room. When there are 4 panels, preferred and standard configurations include LLRR (without a T-post, LLTRR (two bi-fold pairs hinged opposite the T-post, RRTLL (two bi-fold pairs hinged at the T-post), and LRTLR (four individual panels, hinged at the window sides and the T-post). When the window is sufficiently wide that the T-post is normally preferred (but not so wide as to favor the LRTLR configuration), the LLTRR configuration is preferably the default (as shown in FIG. 4B), otherwise LLRR is the preferred default 4-panel configuration for smaller sizes, LRTLR being the preferred default configuration for larger sizes. Other standard configurations can include L and R for a single panel, LR, LL, and RR for two panels, LLR and LRR for three panels, and LTLLRRTR, RTLLRRTL, LLTLRTRR, and RTLLRRTL for six panels.

Associated with the FOLD zone 474 is a T-POST zone 481 for specifying the position(s) of T-post(s) that have been included in the selected panel fold configuration. A STANDARD T-post radio button 484, when activated, defines standard position(s), which may be predetermined based on equal panel sizes, standard panel sizes, and/or combinations of standard and equal panel sizes. A non-standard T-post radio button, when activated, enables a first T-post position window group 486 and, when two T-posts are specified, a second T-post position window group 489. As before, the window group 486 includes a first T-post inch window 486A, a first T-post numerator window 486B having an expansion button 487, and a first T-post denominator window 486C having an expansion button 488; and the window group 489 includes a second T-post inch window 489A, a second T-post numerator window 489B having an expansion button 490, and a second T-post denominator window 489C having an expansion button 491, for specifying T-post positions relative to the left side of the window opening. It will be understood that other window references can be used, such as from the right side or from the center of the window opening. Also, the position of the center of the T-post is specified, it being understood that other T-post references such as the near side can be used.

The exemplary order form 400 also includes a DIVIDER RAIL zone 492 for specifying an optional divider rail which is normally recommended when the panel length is particularly long (tall). As further shown in FIG. 4B, the zone 492 includes a rail REQUIRED radio button 493, a RAIL AT CENTER radio button 494, a rail as specified radio button 495, and a no rail radio button 496. Associated with the as specified button 495 is a rail position window group 497 including a rail inch window 497A, a rail numerator window 497B having an expansion button 498, and a rail denominator window 497C having an expansion button 499, for specifying the height of the center of the divider rail relative to the bottom of the window opening. Preferably, the rail REQUIRED and RAIL AT CENTER radio buttons 493 and 494 are automatically activated when the panel height exceeds a predetermined dimension, which can be dependent on the series as selected using the SERIES (or Program) selection window 416. The base computer 12 can be further programmed for displaying a warning such as that warranties are void when no divider rail is specified beyond a predetermined panel height.

Associated with the DIVIDER RAIL zone 492 is a DOUBLE HUNG zone 500 for specifying that option when a recommended divider rail is not ordered. As further shown in FIG. 4B, the zone 500 includes a double hung REQUIRED radio button 501, a double hung AT CENTER radio button 502, a double hung as specified radio button 503, and a no double hung radio button 504. Associated with the as specified button 503 is a double hung position window group 505 including a rail inch window 505A, a rail numerator window 505B having an expansion button 506, and a rail denominator window 505C having an expansion button 507, for specifying the height of the gap between panel portions relative to the bottom of the window opening. Preferably, the double hung REQUIRED and double hung AT CENTER radio buttons 501 and 502 are automatically activated when the panel height exceeds the predetermined dimension and the divider rail is not specified. The double hung option can be disabled when certain configurations inconsistent with that option have been specified. For example the option can be made available only when single panel fold configurations are selected.

An additional feature present in the exemplary order form 400 is a CARVED RAIL zone 508 for specifying relief designs on portions of the louver assembly. A design LOCATION selection window 509 having an expansion button 510 facilitates user selection of where selected designs are to be included, and a DESIGN selection window 511 having an expansion button 510 facilitates user selection of a particular design. Exemplary selections displayed upon opening the LOCATION selection window 509 can include “TOP & BOTTOM”, “LEFT & RIGHT”, “FOUR SIDES”, “TOP AND DIVIDER” (when a divider rail is specified), etc. It will be understood that the DESIGN selection window 511 is activated only after an appropriate selection is made in the LOCATION selection window 509. Exemplary selections displayed upon opening the DESIGN selection window 511 can include “ROSETTE”, “FISH”, “SWANS”, “WHEAT”, and “VINE”. Preferably the DESIGN selection window 511 has a design view button 513 associated therewith for displaying the appearance of the selected design.

A further feature of the exemplary order form 400 is an ARCH zone 514 having a “NO” radio button for specifying none (default condition automatically activated), a “YES” radio button 516, and an associated item match entry window 517. Additional features of the ARCH zone which can be provided (not shown), include windows for specifying different arch shapes, different orientations of louvers in arches, and arch frame configurations such as no frame, frame included in rail, and separate rail and frame. Further possible specifications are separate arches, arches integrated with rectangular louvers, with or without divider strips, and “rake” (diagonal top) configurations. Further, configurations having polar and/or vertical symmetry can be specified, such as circular and various regular and non-regular polygonal shapes.

Also, a QUANTITY entry window 518 of the order form 400 facilitates ordering multiple items with same or similar specifications, and a comment entry window 520 having a slider 521 facilitates communication of special instructions by the user. The base computer 12 can be programmed such that entry of an integer greater than one (the default value) in the QUANTITY entry window 518 causes duplicate items (with corresponding item numbers) to be automatically entered. The user would need only to change certain specifications, such as only the window location in the case of exact duplication, to complete the specification of multiple quantities. Special instructions can include specification of extension frames for providing extra outward frame spacing for louver clearance

Although the present invention has been described in considerable detail with reference to certain preferred versions thereof, other versions are possible. For example, the base computer 12 can be integrated with the remote computer 42. Therefore, the spirit and scope of the appended claims should not necessarily be limited to the description of the preferred versions contained herein.

1. A computer based order management system comprising:
(a) a computer having program memory, working memory, and data memory;
(b) a graphical user interface operatively connected to the computer; and
(c) the computer being programmed for:
(i) displaying an order form comprising a sequence of selection windows for receiving respective specifications of a custom product being ordered by a user of the system, the selection windows displaying specification options as defined by stored product data of the data memory; and
(ii) at least some of the selection windows displaying restricted specification options dependent on previously selected specifications, for avoiding selection of inconsistent specifications by the user.

2. The system of claim 1, further comprising a network interface for permitting the graphical user interface to be remotely connected to the computer.

3. The system of claim 2, wherein the graphical user interface is directly connected to the computer, the network interface permitting plural counterparts of the graphical user interface to be operatively connected to the computer for access by multiple users.

4. The system of claim 2, wherein the network interface is implemented for communication over a publically accessible network.

5. The system of claim 4, wherein the publically accessible network is the Internet.

6. The system of claim 4, wherein the computer is programmed for log-in of users for limiting access to the order form to authorized users.

7. The system of claim 2, wherein the computer is further programmed for transmitting the specifications ordered by the user to a remote facility for filling the order.

8. The system of claim 1, wherein the order form further comprises an entry window for receiving a numerical specification element, an associated selection window being selectively disabled depending on comparison of the numerical specification element with a predetermined value.

9. The system of claim 8, wherein the associated selection window has set of selection options, a subset only of the selections being disabled in response to entry of the numerical specification element.

10. The system of claim 8, wherein the associated selection window has a default setting, the default setting being dependent on user input at the entry window.

11. The system of claim 1, wherein the selection windows include a selection button, the computer being further programmed for changing the specification options in another of the selection windows in response to operation of the selection button.

12. The system of claim 1, wherein one of the selection windows has a default setting, the default setting being dependent on user input at a different selection window.

13. A computer based order management system comprising:
(a) a computer having program memory, working memory, and data memory;
(b) a graphical user interface operatively connected to the computer[
(c) a network interface for permitting plural counterparts of the graphical user interface to be remotely connected to the computer for access by multiple users; and
(d) the computer being programmed for:
(i) log-in of users for limiting access to the order form to authorized users;
(ii) displaying an order form comprising a sequence of selection windows for receiving respective specifications of a custom product being ordered by a user of the system, the selection windows displaying specification options as defined by stored product data of the data memory, at least some of the selection windows displaying restricted specification options dependent on previously selected specifications;
(iii) the order form further comprising an entry window for receiving a numerical specification element, an associated selection window being selectively disabled depending on comparison of the numerical specification element a predetermined value, for avoiding selection of inconsistent specifications by the user; and
(iv) transmitting the specifications ordered by the user to a remote facility for filling the order.

14. The system of claim 13, wherein the associated selection window has set of selection options, a subset only of the selections being disabled in response to entry of the numerical specification element.

15. The system of claim 13, wherein the associated selection window has a default setting, the default setting being dependent on user input at the entry window.

16. The system of claim 13, wherein the selection windows include a selection button, the computer being further programmed for changing the specification options in another of the selection windows in response to operation of the selection button.

17. The system of claim 13, wherein one of the selection windows has a default setting, the default setting being dependent on user input at a different selection window.

18. A method for interactively entering custom product orders for complex custom goods, comprising:
(a) providing a computer having control of a graphic user interface;
(b) under control of the computer, displaying an order form comprising a sequence of selection windows;
(c) displaying specification options in association with respective ones of the selection windows as defined by stored product data of the data memory;
(d) sequentially receiving in the selection windows respective specifications of a custom product being ordered by a user of the system; and
(e) in association with at least some of the selection windows, restricting the display of specification options dependent on previously selected specifications, for avoiding selection of inconsistent specifications by the user.

19. The method of claim 18, further comprising displaying a selection window as a selection button, changing the specification options in another of the selection windows in response to operation of the selection button.

20. The method of claim 19, further comprising the steps of receiving a numerical specification element from the user, and selectively disabling particular ones of the specification options not yet specified depending on comparison of the numerical specification element with a predetermined value.

21. The system of claim 19, further comprising the step of providing a default setting of one of the selection windows, the default setting being dependent on user input at a different selection window.

22. The method of claim 18, further comprising transmitting the specifications ordered by the user to a remote facility for filling the order.
